(19) United States
(12) Patent Application Publication
(10) Pub. No.: US 2010/0088436 A1
(43) Pub. Date: Apr. 8, 2010

(54) COMMUNICATION METHOD AND INTERFACE BETWEEN A COMPANION CHIP AND A MICROCONTROLLER

(76) Inventors: Matthias Knauss, Schorndorf (DE); Stefen Schmitt, Nuertingen (DE); Juergen Hanisch, Bempflingen (DE)

Correspondence Address: MICHAEL J. STRIKER, 103 EAST NECK ROAD, HUNTINGTON, NY, 11743, US

(21) Appl. No.: 12/527,010

(22) PCT Filed: Jul. 23, 2008
(86) PCT No.: PCT/EP08/59637

§ 371 Date: Aug. 13, 2009

(30) Foreign Application Priority Data
Aug. 16, 2007 (DE) 102007038544.9

(51) Int. Cl. G06F 13/28

(52) U.S. Cl. 710/35

(57) ABSTRACT

The invention relates to a communication method and interface between a companion chip (CC) and a microcontroller (MC), a communication protocol being transmitted, having a first group of data (10) being drawn on for direct, non-real-time-critical access to the chip (CC), and a second group of data (20) based on which a real-time-critical access to the chip (CC) takes place, the data groups (10, 20) each comprising an operation code (OC), the length of which is shorter in the second data group (20) than in the first data group (10), and each data group (10, 20) being identifiable by the bit pattern of the operation code (OC).

### BACKGROUND INFORMATION

The present invention relates to the communication between a companion chip and a microcontroller. The companion chip is referred to below as the companion chip.

In engine management systems for motor vehicles, in order to realize, e.g. an injection function, only the information regarding the start of injection and the angle, i.e. when injection should take place, is exchanged between a processor kernel PCP (Peripheral Control Processor) and peripheral components. The rest of the information is handled separately in a closed loop, independently of the PCP. The duration and quantity of the injection are calculated from the rotational speed and position of the engine.

FIG. 1 shows a known control loop for the injection function, which includes a TriCore™ controller for controlling type CY371 or CY372 injection ICs, IC-I (Integrated Circuit-Injection). A rail pressure is measured shortly before injection takes place, to ensure that the injection may take place in as precise a manner as possible. In a first step S1 (step 1), this rail pressure is read-in directly via an analog/digital converter ADC (analog/digital controller), and it is made available in a second step S2 (step 2) to the PCP for calculation of injection parameters. In a third step S3 (step 3), the PCP transmits the calculated parameters via an interface combination SSC (Serial Synchron Controller) and SPI (Serial Peripheral Interface Controller) to the injection IC. In a fourth step S4 (step 4), a timer GPTA (General Purpose Timer Array) starts or stops the injection in cylinder C1 . . . C3 or C4 . . . C6 (cylinder 1 . . . 6) via banks B1 and B2 (banks 1 and 2) to which they are assigned. A similar control loop results for rotational speed detection.

The bandwidth of the SPI interface between the TriCore™ controller and CY37x proves to be a growing problem, however. At the moment, 2 MBaud of data are transmitted in the burst mode. Capacitive effects may play a role in the reason why the throughput for the SPI interface is limited to 2 MBaud. Since the controller must serve up to seven slaves, the time for the edge ramp-up in the line is very long. This may also be due to the drivers in the controller being too slow. The bandwidth limitation may have to do with the software, however.

These problems also exist in the communication between a companion processor and a microcontroller, the rapid coupling of which is particularly important.

### DISCLOSURE OF THE INVENTION

The object of the present invention is to provide a simple and cost-effective interface between a companion chip and a microcontroller that simultaneously permits a higher data transmission rate.

This object is attained via a communication method between a companion chip and a microcontroller, in the case of which a communication protocol is transmitted including a first group of data which is used for direct, non-real-time-critical access to the chip, and including a second group of data, based on which real-time-critical access to the chip takes place, the data groups each comprising an operation code, the length of which is shorter in the second data group than in the first data group, and each data group being identifiable via the bit pattern of the operation code.

An essential point of the method according to the present invention is that the communication protocol makes it possible to access the companion chip in a manner that has been optimized in terms of speed, in addition to enabling a direct single access and burst access to the companion chip. This method makes it possible to use a synchronous—or, as an alternative, an asynchronous—serial interface to transmit the data. Compared to a faster parallel interface, much fewer PINs are required, thereby saving space, i.e. it is simpler to realize and is therefore more cost-effective. Depending on further speed requirements, the method may be implemented in hardware and in software.

Preferred developments of the method according to the present invention are mentioned in dependent claims 2 through 4.

According thereto, it is provided in an advantageous embodiment that the bit pattern of the operation code contains information on whether the first group of data is used for a single access or burst access to the companion chip. Via the additional burst mode, accelerated direct access to the data is therefore also made possible.

In a preferred manner, the bit pattern of the operation code contains information on whether a direct access to the modules or FIFOs of the chip is carried out. Certain modules of a companion chip may therefore be addressed explicitly.

It is also preferable for the bit pattern of the operation code to contain information that characterizes the results of an asynchronous read access, and via which the access may be identified. As a result, e.g. responses of the companion chip to concurrent read requests from a microcontroller may be allocated and managed.

The present method may be embedded in a computer program that may be loaded in the internal memory of a digital computer system. The program includes software code parts for carrying out the method when the computer program runs on the computer system. This software-based realization of the method makes it possible, in particular, to utilize standardized microcontrollers in order to implement the method.

The method may also be designed as a computer program product that includes a computer-readable medium that contains program instructions that may be implemented by a computer, and in the case of which the program instructions contain the computer program described above. The method may therefore be transferred particularly easily to other computer systems.

The object described above is also attained via a communication interface between a companion chip and a microcontroller, and which is designed to carry out the communication method.

Due to the rapid access method, an essential point of the communication interface according to the present invention is its openness as compared to broad standards. A large number of possible microcontrollers may therefore be considered for use in control devices. There are two basic possibilities for selecting the interface.

The first possibility is to implement a parallel interface with data, address, and control signals. An interface of this type has the advantage that high data transmission rates between the microcontroller and the companion chip may be attained. It has the disadvantage, however, that a parallel interface requires a very large number of pins. For example, the EBU (External Broadcasting Unit) of the TriCore™ controller includes forty pins for connecting external peripheral components. Moreover, only microcontrollers that include an external parallel interface may then be considered. Future microprocessors will only have a point-to-point connection to the flash, however, and they will not support any further participants on this bus.

According to a second possibility, a serial interface is used to connect the companion chip. This interface has the advantage that it is very widespread, and virtually every microprocessor includes one or more synchronous and asynchronous serial interfaces. The disadvantage of this interface is that its bandwidth is limited, requests are not prioritized, and problems related to EMC (electromagnetic compatibility) may occur.

Preferred developments of the communication interface according to the present invention are mentioned in dependent claims 8 through 11.

In an advantageous embodiment it is provided that the communication interface is designed for the synchronous serial transmission of data. The selection of the microcontroller is therefore not limited by the interface of the companion chip, and the costs for the entire system are kept low. The above-mentioned disadvantages of serial interfaces are eliminated via the implementation of the method according to the present invention. A suitable software protocol is therefore loaded on the serial interface, and a related hardware support of the protocol is realized in the companion chip. Basically, however, the protocol may also be realized as software in the companion chip. To support optimized access, it is advantageous in both cases for the interface to be designed to prevent an access from taking place in addition to a real-time-critical access.

The interface is preferably designed for direct access by the microcontroller to a memory of the companion chip. This prevents, e.g. data mirroring between the microprocessor and the companion chip, which would require a greater bandwidth for the connection.

It is also preferable for the interface to be designed to transfer data in a time frame of up to 5 μs to 10 μs. This time frame defines the period of time in which the data are transmitted; the transmission rate is approximately 20 MHz, for a period lasting 5 ns. As mentioned above, a serial interface should be used for the communication between the microcontroller and the companion chip, since this increases the amount of freedom allowed in selecting the controller. Using the bandwidth mentioned above, an interface of this type is capable of fulfilling a latency for transmitting the data to measure and control a rail pressure.

The object described above is also attained via a companion chip, in the case of which a hardware interpreter module is provided to process the communication protocol according to the present invention.

An essential point of the companion chip according to the present invention is that a protocol may be implemented rapidly without this type of implementation limiting the types of microprocessors that may be used.

Advantageous developments of the companion chip according to the present invention are mentioned in dependent claims 13 and 14.

According thereto, it is provided in an advantageous embodiment that the hardware interpreter module is designed to modify the operation code of the second group of data. As a result, real-time-critical communication may be implemented between the microcontroller and the companion chip using a shorter operation code which is implemented once more in the companion chip.

It is preferable for the companion chip to include a functionality for processing speed data, injection data, and/or ignition data in order to effectively support the control tasks of the microcontroller.

The microcontroller is preferably equipped with a software interpreter module for carrying out the method according to the present invention, and which enables it to be adapted to the companion chip according to the present invention.

### BRIEF DESCRIPTION OF THE DRAWING

The communication method according to the present invention, and the companion chip are described in greater detail below with reference to an embodiment. Identical or identically-acting parts are labelled using the same reference numerals.

FIG. 1 shows a known control loop for the injection function, including a TriCore™ controller for controlling type CY371 or CY372 injection ICs;

FIG. 2A shows a desired regulation between a companion chip and a microcontroller, in the case of which an activation duration is adapted to a current rail pressure;

FIG. 2B shows a diagram which depicts the approximate time-related behavior of the desired regulation in FIG. 2A;

FIG. 4A shows a coding of the operation code according to the present invention for a direct single access to the companion chip;

FIG. 4B shows a coding of the operation code according to the present invention for a direct burst access to the companion chip;

FIG. 5 shows a coding of the operation code according to the present invention for a direct burst access to FIFOs of the companion chip;

FIG. 6 shows an address implementation of the operation code according to the present invention in the case of a real-time-critical access to the companion chip;

FIG. 7 shows the basic principle of the synchronous serial communication using the example of a microcontroller and a companion chip;

FIG. 8 shows latency plotted against the number of data words for a synchronous serial data transmission, according to the present invention, at 37.5 Mbaud, and

FIG. 9 shows a schematic depiction of a companion chip CC according to the present invention, showing its hardware architecture.

### EMBODIMENTS OF THE INVENTION

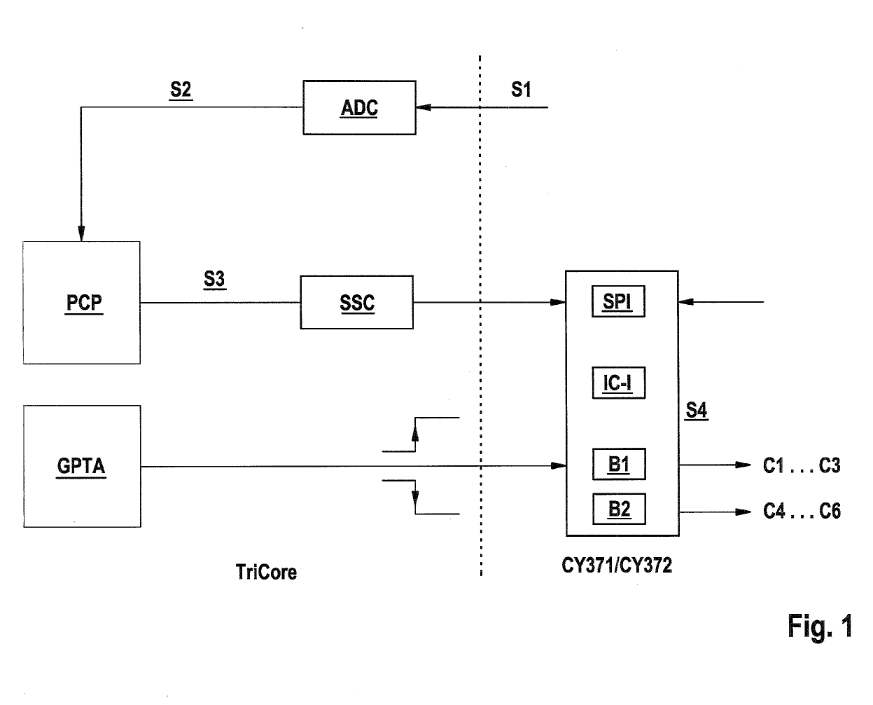

FIG. 1 shows a known control loop for the injection function, including a TriCore™ controller for controlling a type CY371 or CY372 injection ICs IC-I (Integrated Circuit-Injection), as described above. The bandwidth of the SPI interface between the TriCore™ controller and CY37x proves to be a problem. The problem is similar with regard for communication between a companion chip and a microcontroller.

For this reason, the requirements on the communication interface between a microcontroller and a companion chip in terms of the speed and injection functionalities will be described in greater detail below before discussing the implementation at the interface according to the present invention.

To measure rotational speed, given 60 teeth and 10,000 rpms per tooth, there are 100 μs available to reset the time base of a timer. In worst-case scenarios, this time is shortened to 25 μs. This is the case in areas having special requirements that use gears that include up to 147 teeth. The tooth counter data must be transmitted using 16 bits, the index data using 16 bits, the time stamp data using 24 bits, and the angle stamp data using 24 bits. Today, the data are transmitted to the companion chip using 3 times 32 bits. If optimized, the transmission could be carried out using 80 bits. The transmission is necessary since the rotational speed software requires a very large quantity of application data. The communication for the rotational speed function takes place mainly from the companion chip to the microcontroller. By moving the rotational speed function to the companion chip, the computing power at the highest rotational speed may be reduced by 5-6%.

For injection control, communication must take place in both directions. The reason for this is application data that are located in the (flash) memory of the microcontroller. Today, parts of these data are already located in the vicinity of the PCP, which causes problems. To increase security, checking mechanisms are advantageously included in the communication protocol between the microcontroller and the companion chip. A parity check would be sufficient since it is possible for an injection to become lost. For the injection function, the following requirements are placed on the communication interface between the microcontroller and the companion chip.

A total of 2.5 KB of RAM data must be mirrored, or it must be possible to access the memory of the companion chip via the communication interface. Due to the limited bandwidth, it should be possible to access the microcontroller in the memory region of the companion chip.

The activation duration depends on the measurement of the rail pressure, which requires that stringent real-time requirements be met. The time available for data transmission is between 5 μs and 10 μs. The remaining time is required to calculate the control algorithm.

Given 5000 revolutions, four cylinders, and three injections, a BIP (Begin of Injection Point) data rate of 0.8 MbH/s occurs. The transit time for the BIP detection is 30-60 μs.

In the future, an EIP (End of Injection Point) should also be found, which would result in twice as many values.

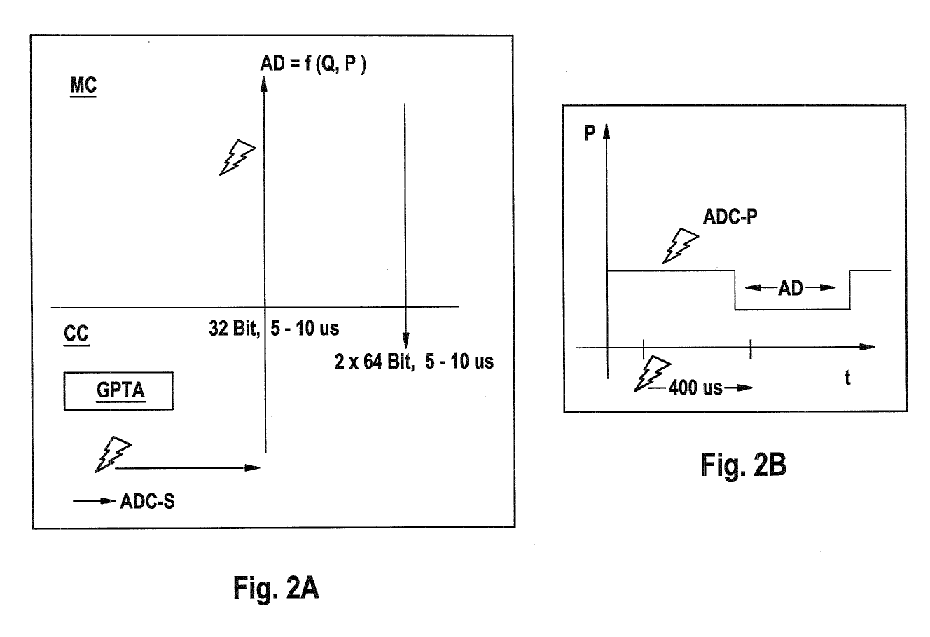

FIG. 2A shows a desired regulation between a companion chip CC and a microcontroller MC, in the case of which an activation duration AD is adapted to a current rail pressure ADC-P (Analog/Digital Controller Pressure). Via the angle clock of a timer GPTA in the companion chip CC, the recording of a measurement signal ADC-S (Analog/Digital Controller Sampling) is initiated, as indicated by the black thunderbolt. Once measurement ADC-S is concluded, the ADC triggers a dynamic interrupt on microcontroller MC, as indicated by the white thunderbolt. Subsequently, 32 bits of data are transmitted in approximately 5 μs to 10 μs from the companion chip CC to the microcontroller MC. On controller MC, activation duration AD is then calculated as a function f of a fuel quantity requirement Q and rail pressure ADC-P. The result is transmitted as 2 times 64 bits of data in approximately 5 μs to 10 μs from controller MC back to companion chip CC which then controls the valves of an engine beyond the activation duration AD.

FIG. 2B shows a diagram in which the approximate time-related behavior of the regulation in FIG. 2A is depicted. Rail pressure ADC-P is plotted against time t. The period of time that passes between the recording of a measurement ADC-S at the instant indicated by the black thunderbolt, and the start of valve control is 400 μs. Within this period of time, activation duration AD is calculated on microcontroller MC, starting at the instant indicated by the white thunderbolt.

FIG. 3A shows a communication protocol according to the present invention for direct access to a companion chip CC. The protocol is divided into two data groups 11 and 12.

In first group 11, the non-real-time-critical communication with companion chip CC is realized using single accesses and burst accesses. In addition, an optimized protocol 12 is introduced for burst accesses. The two variants are shown in FIG. 3A. One frame of the protocol is composed of a header and data D0, D1 . . . Dx of variable length L, the data being defined by an operation code OC. For direct access, operation code OC is composed of 32 bits.

FIG. 3B shows a communication protocol according to the present invention for accessing a companion chip CC in a manner was optimized in a real-time-critical manner. A second data group 20 is provided, operation code OC of which has a width of 8 bits and follows data D0 . . . Dx. The real-time-critical communication is identified by a logical 0 in bit 7 of operation code OC. The data traffic between microcontroller MC and companion chip CC is reduced by shortening operation code OC of the optimized access by 8 bits as compared to direct access.

In all, a protocol of this type results in the bandwidth required at a serial connection. The protocol is implemented in companion chip CC via a module in the hardware, thereby relieving a microprocessor in companion chip CC of this task, and since the communication protocol for connecting the microcontroller is fixedly specified. With regard for microcontroller MC, the protocol must be implemented in the software, so that it may be applied there at a standardized interface.

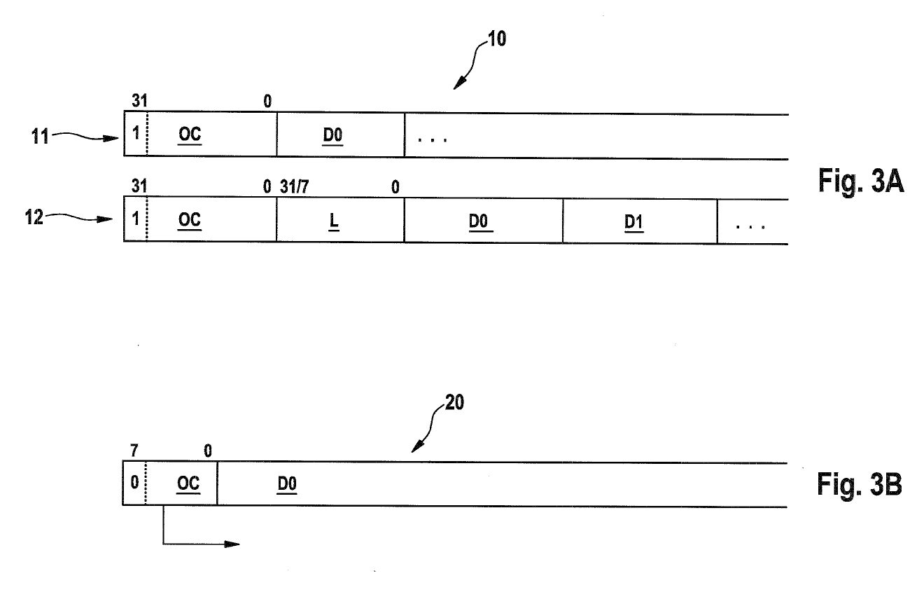

FIG. 4A shows a coding of operation code OC according to the present invention for a direct single access to companion chip CC. Direct accesses are characterized by a logical 1 in operation code bit 31; single access is defined by a 0 in bit 30, and by an address increment of 0 in bit 29. Next comes information for read/write access R/W in 28, a format F in bits 26 and 27, an identification number ID in bits 20 through 25, and an address A in bits 16 through 19 and in bits 0 through 15.

FIG. 4B shows a coding of operation code OC according to the present invention for direct burst access to companion chip CC. This is also characterized here by a logical 1 in operation code bit 31, and a further definition is provided using a 1 in bit 30, and an address increment of 1 in bit 29. The rest of the information is the same as in FIG. 4A.

The coding of the two direct accesses therefore takes place via operation code bits 31 and 30. Bit 28 identified a read access (0) or a write access (1) to companion chip CC. Via the format, it is specified whether the access has a width of one byte, one half-word, or one word. The ID is used to identify responses from companion chip CC to concurrent read requests from microcontroller MC. A 20-bit address space is available for addressing the modules and memory components of companion chip CC. For burst accesses, operation code OC is followed by a field that defines the number of data words that follow a communication between microcontroller MC and companion chip CC in the transmission frame. An exact specification of the width of the fields may be defined based on the specific application.

As a result, direct and optimized accesses to modules of companion chip CC are made possible. In addition, certain modules of chip CC may also be addressed.

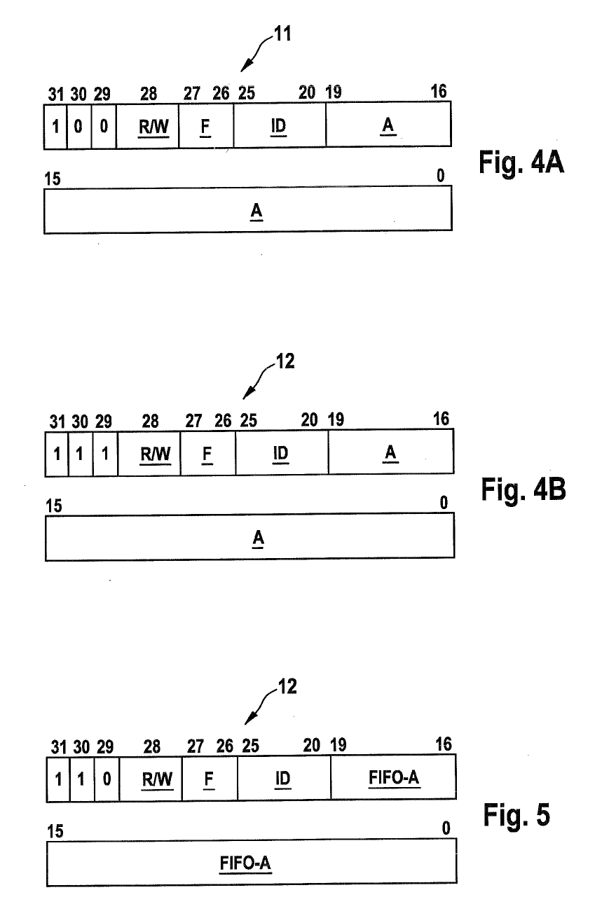

FIG. 5 shows a coding of operation code OC according to the present invention for direct burst access to FIFOs of companion chip CC. The coding of these accesses takes place via operation code bits 30 and 29. Address field A then contains the address of the FIFO stack at which the burst access should take place.

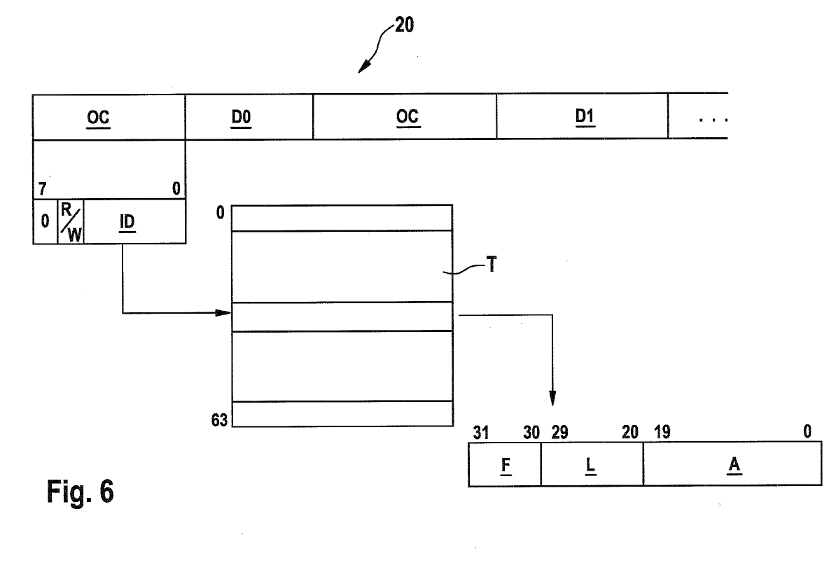

FIG. 6 shows an address implementation of operation code OC according to the present invention for a real-time-critical access to companion chip CC. To reduce the data traffic between microcontroller MC and companion chip CC, an optimized access having an operation code composed of 8 bits is implemented for the real-time-critical communication. In this case, an implementation of the operation code on 32 bits is carried out inside companion chip CC. The optimized access is identified via bit 7 of the operation code which is initialized using 0. Bit 6 specifies a read access (0) or a write access (1). Bits 5 . . . 0 code an index IC in table T which is configurable and contains more exact information about the access to companion chip CC. There, format F and length L of the access, and an address A of the intended module are specified. Microcontroller MC may access the contents of address implementation table T in a write and read manner. The table is a component of an interpreter of companion chip CC.

All common microcontrollers today have a synchronous serial interface SPI which could be operated using a higher clock frequency.

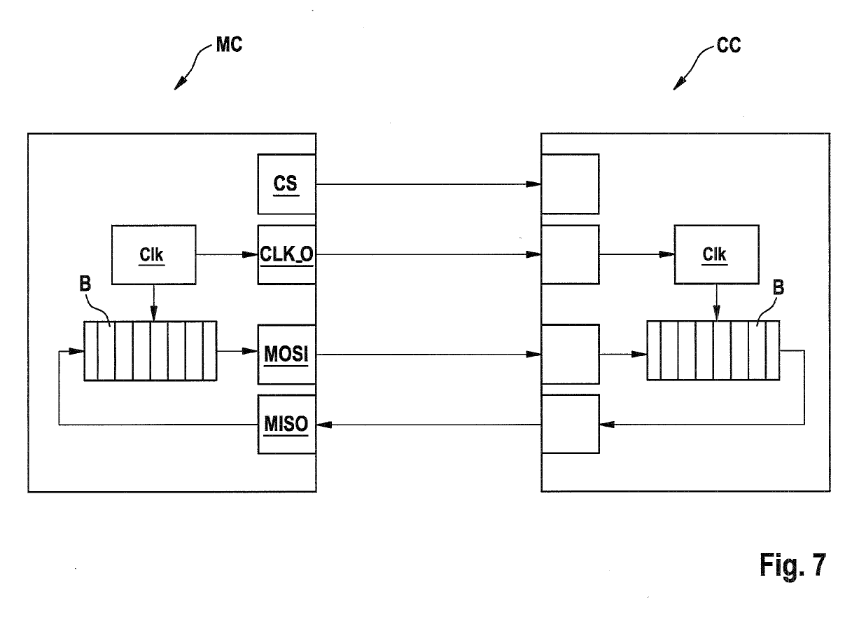

FIG. 7 shows the basic principle of the synchronous serial communication using the example of a microcontroller MC and a companion chip CC. Each of them includes a data buffer B and a clock component Clk. A data signal MOSI (MasterOut/SlaveIn) and a clock and ChipSelect signal CLK_0 (Clock 0) and CS (ChipSelect), respectively, are transmitted from microcontroller MC to chip CC. Moreover, a second signal MISO (MasterIn/SlaveOut) is used to transmit data from chip CC to controller MC. For this reason, three signals plus the number of ChipSelect signals are required for a synchronous serial transmission. Due to the cycle that is transmitted, it is not necessary in the case of synchronous data transmission over a serial line to introduce a protocol having start and stop bits. The overhead relative to the useful data is therefore eliminated. On the other hand, a check of the communication on the hardware side using parity bits is carried out for asynchronous transmission. For synchronous transmission, this may be carried out in the software protocol.

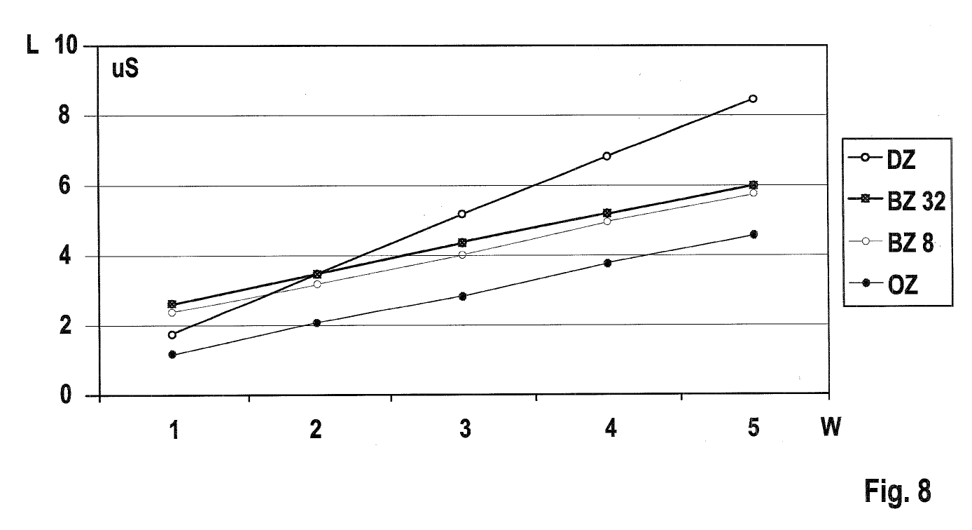

FIG. 8 shows latency L plotted against the number of data words W for a synchronous serial data transmission, according to the present invention, at 37.5 Mbaud, which is supported by the TriCore™ controller. As shown in the figure, the 128-bit data for the injection may be transmitted from microcontroller MC to companion chip CC with all above-described software protocols within the framework of the real-time requirements. An optimized access is not necessary in this case. Due to the lack of prioritization, however, burst accesses should be allowed to be carried out only during the boot procedure, and not during on-going operation. It is shown that for 2 times 64 bits of data, at a transmission rate of 20 MBaud, a latency of 10 μs is just reachable for asynchronous transmission. It is not possible to perform another data transfer. At 37.5 MBaud of synchronous transmission, optimized access is not necessary. For synchronous access, a latency of 10 μs is secured for 14 Mbaud via an optimized access OZ, for 19 Mbaud via a burst access BZ 32 (direct) and BZ 8 (optimized), and for 26 Mbaud via direct access DZ. This means that, for communication between microcontroller MC and companion chip CC, a synchronous serial interface having approximately 20 MBaud is required to meet the requirements of the application for rotational speed detection and injection.

As mentioned above, communication via a synchronous interface does not offer support for parity bits on the hardware side. This has the advantage that a higher useful data rate may be attained, but security is reduced as a result. A parity mechanism may also be implemented via SPI in the software, however. In addition to parity bits, for the SPI interface, it is also possible to read back sent data from a master, or to package a CRC (Cyclic Redundancy Check) in a message.

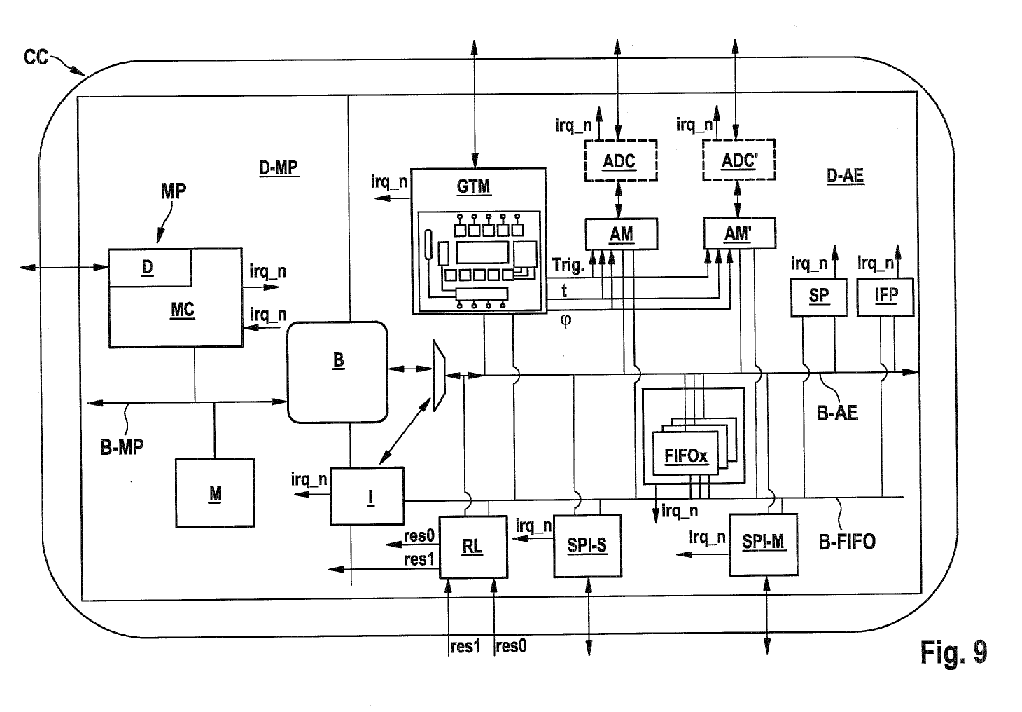

FIG. 9 shows a schematic depiction of a companion chip CC according to the present invention, showing its hardware architecture. The number of modules and their internal structure is scalable for different engines and motor vehicle classes. The figure shows the architecture for a 4-cylinder diesel engine. Companion chip CC is composed of two bus domains D-MP (Domain MicroProcessor) and D-AE (Domain-Automotive Electronics), whose busses B-AE (Bus-Automotive Electronics), B-FIFO (Bus-FIFO) and B-MP (Bus-MicroProcessor) are interconnected via a bus bridge B (Bridge). It is therefore possible to replace a microprocessor MP without this influencing the hardware architecture in the AE bus domain. In addition to a dedicated timer module GTM (Generic Timer Module), companion chip CC contains modules for communicating with the outside world ADO (Analog/Digital Controller), SPI (Serial Peripheral Interface), RL (Reset Logic), and D (Debugger), and for signal processing SP (Signal Processor) and IFP (Integrated Filter Processor).

Microcontroller MC (not depicted) is connected via an SPI slave interface SPI-S (SPI-Slave). The control of external injection ICs then differs in the diesel segment and the gasoline segment. CYx components are used in diesel engines. They are usually equipped with more intelligence and are therefore more expensive. They are connected via a SPI master interface SPI-M (SPI-Master). CJx components are used in gasoline engines. These are simple ICs (Integrated Circuits) that require more control from the outside. Power end stages (H bridges) may be connected via SPI or MSC (Micro Second Channel).

Behind the SPI-S interface an interpreter module I is implemented that implements the protocol for the communication between microcontroller MC and companion chip CC. Interpreter I unpacks data packets arriving from the microcontroller and writes them in First-In-First-Out modules FIFOx which are capable of implementing different request priorities, or it sends direct requests via the AE bus to the modules of companion chip CC. For asynchronous read accesses, i.e. for read accesses that microcontroller MC transmits but for which it does not actively wait, interpreter I must provide the result of the request with an ID, based on which microcontroller MC may identify the response. In addition, interpreter I is responsible for generating the interrupt to microcontroller MC and for transmitting time-critical data on time.

What is claimed is:

1. A communication method between a companion chip (CC) and a microcontroller (MC), in the case of which a communication protocol is transmitted, including a first group of data (10) which is used for direct, non-real-time-critical access to the chip (CC), and including a second group of data (20), based on which a real-time-critical access to the chip (CC) takes place, the data groups (10, 20) each comprising an operation code (OC), the length of which is shorter in the second data group (20) than in the first data group (10), and each data group (10, 20) being identifiable via the bit pattern of the operation code (OC).

2. The method as recited in claim 1, in which the bit pattern of the operation code (OC) contains information on whether the first group of data (10) is used for a single access (11) or a burst access (12) to the companion chip (CC).

3. The method as recited in claim 1, in which the bit pattern of the operation code (OC) contains information on whether a direct access to the modules or FIFOs of the chip (CC) is carried out.

4. The method as recited in claim 1, in which the bit pattern of the operation code (OC) contains information that characterizes the results of an asynchronous read access, and via which the access may be identified.

5. A computer program that may be loaded in the internal memory of a digital computer system, and that includes software code parts for carrying out a method as recited in claim 1 when the computer program is run on the computer system.

6. A computer program product comprising a computer-readable medium that contains program instructions that may be implemented by a computer, and in the case of which the program instructions contain a computer program according to claim 5.

7. A communication interface between a companion chip (CC) and a microcontroller (MC), which is designed to carry out the communication method as recited in claim 1.

8. The interface as recited in claim 7, which is designed for the synchronous serial transfer of data (10, 20).

9. The interface as recited in claim 8, which is designed to prevent an access in addition to a real-time-critical access.

10. The interface as recited in claim 7, which is designed for direct access by the microcontroller (MC) to a memory (M) of the companion chip (CC).

11. The interface as recited in claim 7, which is designed to transfer data (10, 20) in a time frame of up to 5 μs to 10 μs.

12. A companion chip (CC), in the case of which a hardware interpreter module (I) is provided to process the communication protocol as recited in claim 1.

13. The companion chip (CC) as recited in claim 12, in the case of which the hardware interpreter module (I) is designed to modify the operation code (OC) of the second group of data (20).

14. The chip (CC) as recited in claim 12, which includes a functionality for processing rotational speed data, injection data, and/or ignition data.

15. A microcontroller (MC) comprising a software interpreter module for processing the communication protocol as recited in one claim 1.
